(19) United States
(12) Patent Application Publication
(10) Pub. No.: US 2016/0138924 A1
(43) Pub. Date: May 19, 2016

(54) VEHICLE AUTONOMOUS TRAVELING SYSTEM, AND VEHICLE TRAVELING METHOD USING THE SAME

(71) Applicant: ELECTRONICS AND TELECOMMUNICATIONS RESEARCH INSTITUTE, Daejeon (KR)

(72) Inventor: Kyoung Hwan AN, Daejeon (KR)

(73) Assignee: ELECTRONICS AND TELECOMMUNICATIONS RESEARCH INSTITUTE, Daejeon (KR)

(21) Appl. No.: 14/656,172

(22) Filed: Mar. 12, 2015

(30) Foreign Application Priority Data
Nov. 14, 2014 (KR) 10-2014-0158762

(51) Int. Cl. G01C 21/34; G01C 21/30

(52) U.S. Cl. CPC G01C 21/34; G01C 21/30

(57) ABSTRACT

Disclosed are a vehicle autonomous traveling system and a vehicle traveling method using the same. The vehicle autonomous traveling system includes a vehicle navigation device that plans a driver global path to a destination by acquiring a location of a vehicle, and guides a path in accordance with the planned driver global path, an autonomous traveling path providing unit that recognizes a road environment while planning a detailed global path by mapping a partial detailed path of a lane level based on the driver global path, determines a traveling condition based on the detailed global path and the recognized road environment, and outputs vehicle traveling information for controlling the vehicle, and an autonomous traveling operation unit that receives the vehicle traveling information, and performs autonomous traveling of the vehicle by following a path included in the vehicle traveling information.

### CROSS-REFERENCE TO RELATED APPLICATION

This application claims priority to and the benefit of Korean Patent Application No. 10-2014-0158762, filed on Nov. 14, 2014, the disclosure of which is incorporated herein by reference in its entirety.

### BACKGROUND

1. Field of the Invention

The present invention relates to autonomous travel for a vehicle, and more particularly, to a vehicle autonomous traveling system that may not require a detailed map of a lane level for the entire path and prevent an incident that may occur when the autonomous traveling system fails to follow a global path, and a vehicle traveling method using the same.

2. Discussion of Related Art

A vehicle autonomous traveling system refers to a system that recognizes a road environment by itself, determines a traveling condition, and automatically travels to a given destination by controlling a vehicle according to a planned traveling path.

The autonomous traveling system requires a detailed map of a lane level unlike a car navigation system, and such a map requires large construction costs. Also when applying an existing car navigation algorithm only using the detailed map, it takes a lot of time for initial path calculation.

In addition, when path recalculation is delayed in a case in which the autonomous traveling system fails to follow a planned path by road conditions, the corresponding vehicle stops or moves to an unplanned road to cause a dangerous condition.

In a case in which a person is driving a vehicle, when a vehicle navigation system provides only turn information such as in intersections or highway ramps, the corresponding driver performs lane keeping, lane change, stop due to pedestrian crossings or traffic lights, and the like.

However, when the vehicle is driven by the autonomous traveling system, path information and speed information of a lane level on which the vehicle should travel are required. The path information of such a lane level includes coordinates of a center line within the lane, road surface display information such as lanes or stop lines, and the like as well as a road network structure of a lane unit.

Thus, a detailed map for an autonomous traveling vehicle should have high accuracy and have a lot of information to cause an increase in the construction costs, and therefore it is difficult to establish the detailed map on a national scale. However, in cases of highways or main roads which facilitates autonomous traveling and have high effects, or dedicated roads for autonomous traveling vehicles, the detailed map may be preferentially constructed.

In the autonomous traveling system, path planning may be divided into a global path planning and local path planning. In this instance, the global path planning function is a function of planning the entire path from a departure point to a destination to thereby act as a reference path on which the corresponding vehicle should travel, and the local path planning function is a function of generating a detailed path which an actual vehicle should follow for a short time (or distance). In this instance, path planning for a case in which the detailed map partially exists is required.

### SUMMARY OF THE INVENTION

The present invention is directed to a vehicle autonomous traveling system that may prevent an incident that may occur when the autonomous traveling system fails to follow a global path without requiring a detailed map of a lane level for the entire path, and a vehicle traveling method using the same.

According to an aspect of the present invention, there is provided a vehicle autonomous traveling system including: a vehicle navigation device that plans a driver global path to a destination by acquiring a location of a vehicle, and guides a path in accordance with the planned driver global path; an autonomous traveling path providing unit that recognizes a road environment while planning a detailed global path by mapping a partial detailed path of a lane level based on the driver global path, determines a traveling condition based on the detailed global path and the recognized road environment, and outputs vehicle traveling information for controlling the vehicle; and an autonomous traveling operation unit that receives the vehicle traveling information, and performs autonomous traveling of the vehicle by following a path included in the vehicle traveling information.

Here, the vehicle navigation device may include a driver map database that stores a vehicle navigation map, a vehicle location recognition unit that recognizes the location of the vehicle using a positioning system, and a global path planning unit that plans the driver global path of the vehicle using location information recognized by the vehicle location recognition unit and the vehicle navigation map stored in the driver map database.

Also, the autonomous traveling path providing unit may include an autonomous traveling map database that stores a map of a lane level for a predetermined section, a detailed global path planning unit that plans the detailed global path using the map stored in the autonomous traveling map database and the driver global path provided from the vehicle navigation device, a vehicle location recognition unit that acquires the location of the vehicle and heading information of the vehicle, an autonomous traveling environment recognition unit that recognizes the road environment for autonomous traveling, and an autonomous traveling path planning unit that determines the traveling condition based on the detailed global path, the road environment, and location information of the vehicle, and outputs the vehicle traveling information.

Also, when an intersection exists on the driver global path, the autonomous traveling path providing unit may search for a lane-alternative path, and map the searched lane-alternative path on the detailed global path.

Also, the vehicle location recognition unit may be implemented as a global positioning system (GPS)/inertial measurement unit (IMU) for acquiring highly accurate location information.

Also, the vehicle navigation device and the autonomous traveling path providing unit may communicate with each other via a network within the vehicle.

According to another aspect of the present invention, there is provided a vehicle traveling method using a vehicle autonomous traveling system, including: loading a planned detailed global path; acquiring a location of a vehicle to perform map matching on the acquired location; determining whether the vehicle arrives at a destination, and determining whether a partial detailed path exists up to a location ahead by a predetermined distance on the detailed global path when it is determined that the vehicle does not arrive at the destination; performing autonomous traveling or performing map matching on the acquired location by determining whether the vehicle is in an autonomous traveling state when it is determined that the partial detailed path exists; and performing emergency autonomous traveling or performing map matching on the acquired location by determining whether the vehicle is in the autonomous traveling state when it is determined that the partial detailed path does not exist.

Here, the performing of autonomous traveling or the performing of the map matching may include performing autonomous traveling when it is determined that the vehicle is in the autonomous traveling state in a case in which the partial detailed path is determined to exist, and performing map matching on the acquired location when it is determined that the vehicle is not in the autonomous traveling state.

Also, the performing of the map matching may include performing map matching on the acquired position when it is determined that the vehicle is not in the autonomous traveling state.

Also, the performing of the map matching may include requesting driver traveling when it is determined that the vehicle is in the autonomous traveling state, and determining whether the driver traveling is performed.

Also, the determining of whether the driver traveling is performed may include performing map matching on the acquired location when it is determined that the driver traveling is performed, and performing emergency autonomous traveling when it is determined that the driver traveling is not performed.

Also, the performing of autonomous traveling or the performing of the map matching may include determining whether a current link is a link before the vehicle enters an intersection when it is determined that the vehicle is in the autonomous traveling state, performing autonomous traveling when it is determined that the current link is not the link before the vehicle enters the intersection, and determining whether detailed global path following is successfully performed when it is determined that the current link is the link before the vehicle enters the intersection.

Also, the determining of whether the detailed global path following is successfully performed may include performing autonomous traveling when it is determined that the detailed global path following is successfully performed, and resetting the corresponding path to an alternative path when it is determined that the detailed global path following is not successfully performed, and performing autonomous traveling.

Also, the loading of the planned detailed global path may include designating the destination using a vehicle navigation device, searching for a driver global path based on a driver map database in which a vehicle navigation map is stored, and planning(searching for?) the detailed global path by mapping the partial detailed path on the driver global path.

Also, after the mapping of the partial detailed path on the driver global path, the loading of the planned detailed global path may further include searching for an intersection-alternative path by determining whether an intersection exists on the driver global path, and searching for the detailed global path by mapping the intersection-alternative path on the detailed global path.

Also, the planning of the detailed global path by mapping the partial detailed path on the driver global path may include determining whether a next link of the driver global path exists, acquiring the next link when it is determined that the next link of the driver global path exists, and determining whether a partial detailed path for the next link exists, and adding a partial detailed path link to a map set for calculating the detailed global path when it is determined that the partial detailed path for the next link exists, and searching for the detailed global path based on the map set for calculating the detailed global path when it is determined that the partial detailed path for the next link does not exist.

Also, the searching for of the detailed global path based on the map set may include acquiring the map set for calculating the detailed global path, searching for the partial detailed path using the map set for calculating the detailed global path, and searching for the detailed global path by mapping the partial detailed path on the driver global path.

Also, after the adding of the partial detailed path link to the map set for calculating the detailed global path, the planning of the detailed global path by mapping the partial detailed path on the driver global path may further include determining whether the next link of the driver global path exists, and acquiring the next link when it is determined that the next link of the driver global path exists.

Also, the planning of the detailed global path by mapping the partial detailed path on the driver global path may further include determining whether the next link of the driver global path exists, and searching for the detailed global path based on the map set for calculating the detailed global path when it is determined that the next link of the driver global path does not exist.

Also, the searching for of the detailed global path by mapping the intersection-alternative path on the detailed global path may include determining whether a link connected to a next intersection exists in the driver global path, acquiring the link connected to the next intersection when it is determined that the link connected to the next intersection exists in the driver global path, searching for an alternative path of the driver global path by searching for a path until the vehicle meets an existing path using the acquired link as a departure point, searching for the partial detailed path using the searched alternative path, and searching for the detailed global path by mapping the searched partial detailed path on the driver global path.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram illustrating a configuration of a vehicle autonomous traveling system according to an embodiment of the present invention;

FIG. 2 is a block diagram illustrating a detailed configuration of a vehicle navigation device according to an embodiment of the present invention;

FIG. 3 is a block diagram illustrating a detailed configuration of an autonomous traveling path providing unit according to an embodiment of the present invention;

FIGS. 4 and 5 are drawings illustrating road network data of a driver map and an autonomous traveling map which are used for path planning on the same road;

FIG. 6 is a drawing illustrating a mapping process of a driver map and an autonomous traveling map;

FIG. 7 is a drawing illustrating a case in which a normal lane change and a left turn according to global path planning are performed;

FIG. 8 is a diagram illustrating a state in which traveling is not performed according to global path planning;

FIG. 9 is a flowchart illustrating a procedure for planning a global path according to an embodiment of the present invention;

FIG. 10 is a flowchart illustrating a detailed procedure for searching for a detailed global path shown in FIG. 9;

FIG. 11 is a flowchart illustrating a detailed procedure for searching for an intersection-alternative path shown in FIG. 9; and

FIG. 12 is a flowchart illustrating a vehicle traveling method using a vehicle autonomous traveling system according to an embodiment of the present invention.

### DETAILED DESCRIPTION OF EXEMPLARY EMBODIMENTS

Example embodiments of the present invention are disclosed herein. Also, specific structural and functional details disclosed herein are merely representative for purposes of describing the example embodiments of the present invention. However, the example embodiments of the present invention may be embodied in many alternative forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

In the following description, when the detailed description of the relevant known function or configuration is determined to unnecessarily obscure the important point of the present invention, the detailed description will be omitted. Also, the terms described below are defined in consideration of the functions in the present invention, and thus may vary depending on a user, intention of an operator, or custom. Accordingly, the definition would be made on the basis of the whole specification.

Hereinafter, a configuration and function of a vehicle autonomous traveling system according to an embodiment of the present invention will be described in detail with reference to the accompanying drawings.

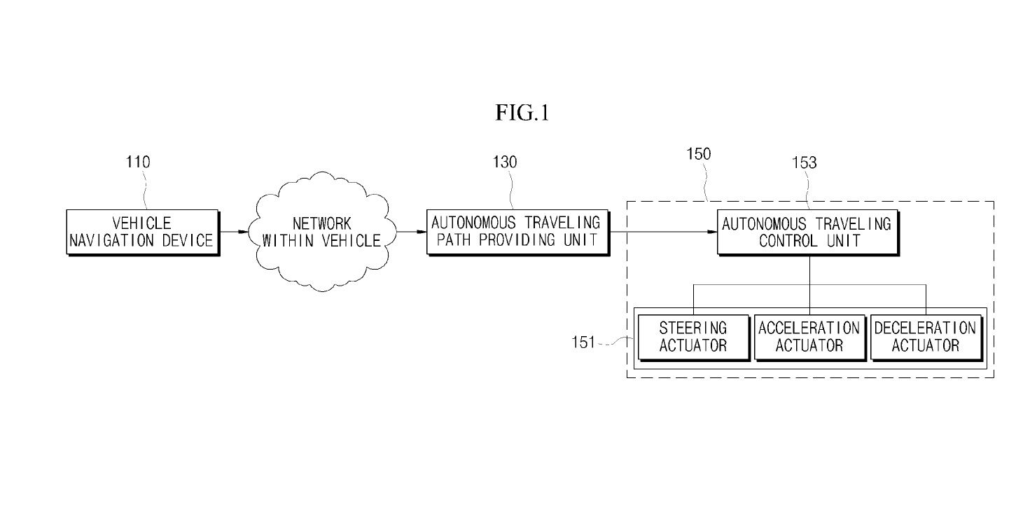

FIG. 1 is a block diagram illustrating a configuration of a vehicle autonomous traveling system according to an embodiment of the present invention.

Referring to FIG. 1, the vehicle autonomous traveling system 100 according to an embodiment of the present invention may include a vehicle navigation device 110, an autonomous traveling path providing unit 130, and an autonomous traveling operation unit 150.

The vehicle navigation device 110 plans a driver global path to a destination by acquiring a location of a vehicle, and guides a path in accordance with the planned driver global path.

The vehicle navigation device 110 may communicate with the autonomous traveling path providing unit 130 via a network within the vehicle, for example, using controller area network (CAN) communication with the autonomous traveling path providing unit 130.

The autonomous traveling path providing unit 130 recognizes a road environment while planning a detailed global path by mapping a partial detailed path of a lane level for autonomous traveling based on the driver global path planned by the vehicle navigation device 110, determines a traveling condition based on the detailed global path and the recognized road environment, and outputs vehicle traveling information for controlling the vehicle.

The autonomous traveling path providing unit 130 communicates with the vehicle navigation device 110 via the network within the vehicle such as CAN communication, and receives a variety of information required for planning an autonomous traveling path from the vehicle navigation device 110.

The autonomous traveling operation unit 150 controls a vehicle traveling actuator in order to perform autonomous traveling of a vehicle in accordance with a local path by following the local path provided by the autonomous traveling path providing unit 130.

In this instance, the autonomous traveling operation unit 150 may include a plurality of actuators 151 and an autonomous traveling control unit 153 that controls the plurality of actuators 151 in order to travel the corresponding vehicle in accordance the local path, and the plurality of actuators 151 may include a steering actuator, an acceleration actuator, and a deceleration actuator.

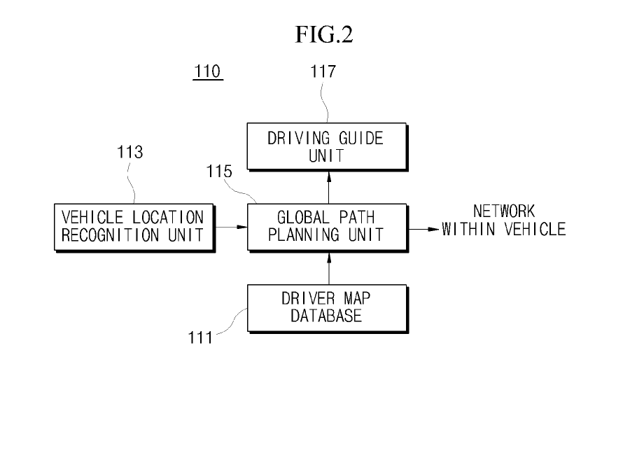

FIG. 2 is a block diagram illustrating a detailed configuration of a vehicle navigation device according to an embodiment of the present invention.

Referring to FIG. 2, the vehicle navigation device 110 may include a driver map database 111, a vehicle location recognition unit 113, a global path planning unit 115, and a driving guide unit 117.

The driver map database 111 stores a vehicle navigation map, and is used to plan a driver global path of the vehicle.

The vehicle location recognition unit 113 recognizes a location of the vehicle using a positioning system such as a global positioning system (GPS).

The global path planning unit 115 plans the driver global path of the vehicle using the location information recognized by the vehicle location recognition unit 113 and the vehicle navigation map stored in the driver map database 111.

The driving guide unit 117 guides the corresponding path in accordance with the driver global path planned by the global path planning unit 115, and exhibits the map and a variety of guide information.

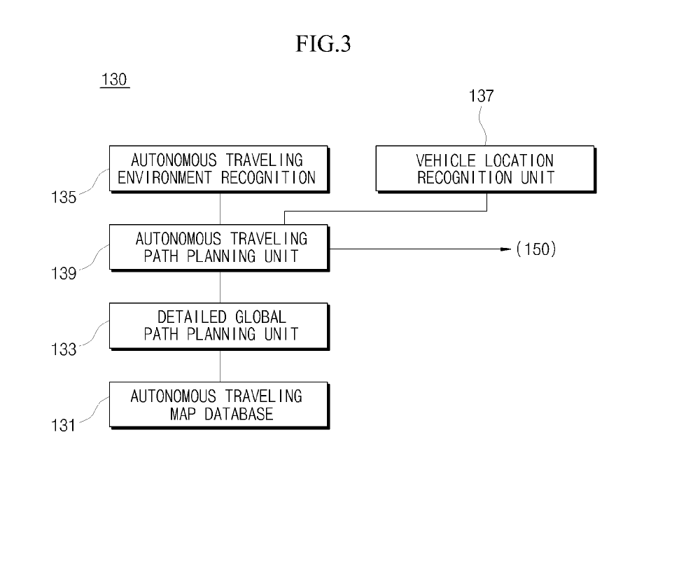

FIG. 3 is a block diagram illustrating a detailed configuration of an autonomous traveling path providing unit according to an embodiment of the present invention.

Referring to FIG. 3, the autonomous traveling path providing unit 130 may include an autonomous traveling map database 131, a detailed global path planning unit 133, an autonomous traveling environment recognition unit 135, a vehicle location recognition unit 137, and an autonomous traveling path planning unit 139.

The autonomous traveling map database 131 stores a map of a lane level for a predetermined section, and is used to plan a detailed global path of the vehicle for autonomous traveling.

The detailed global path planning unit 133 plans a detailed global path of a lane level for autonomous traveling using the map stored in the autonomous traveling map database 131 and the driver global path provided from the vehicle navigation device 110.

The autonomous traveling environment recognition unit 135 recognizes a road environment such as obstacles, road signs, signals, and the like for the purpose of autonomous traveling.

The vehicle location recognition unit 137 may acquire highly accurate location information about the vehicle, may be implemented as a GPS/inertial measurement unit (IMU), and acquire the location information and heading information of the vehicle.

The autonomous traveling path planning unit 139 determines a traveling condition based on the detailed global path planned by the detailed global path planning unit 133, the road environment recognized by the autonomous traveling environment recognition unit 135, and the location information of the vehicle recognized by the vehicle location recognition unit 137.

In addition, the autonomous traveling path planning unit 139 determines operations such as lane followings, lane change, stop lines/traffic lights, stop/start, crossroad passing, and the like, and provides vehicle traveling information for vehicle control.

As described above, in the present invention, the detailed global path has been planned using the 2-level map of a driver map and an autonomous traveling map. Hereinafter, a mapping method of the driver map and the autonomous traveling map using a structure of a road network level of the driver map and the autonomous traveling map will be described.

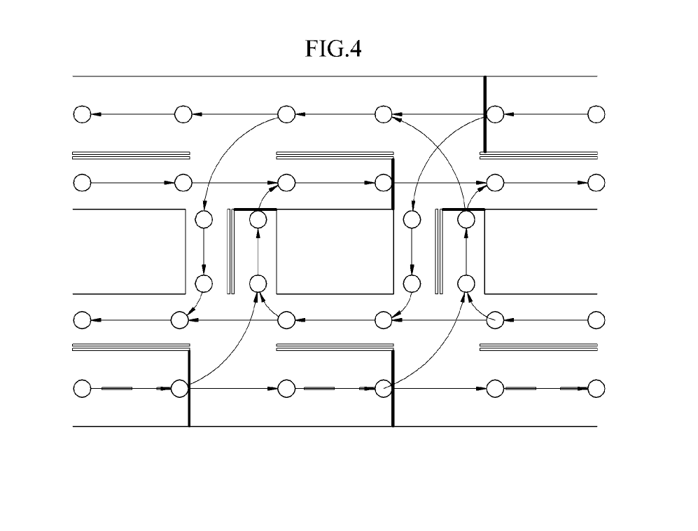

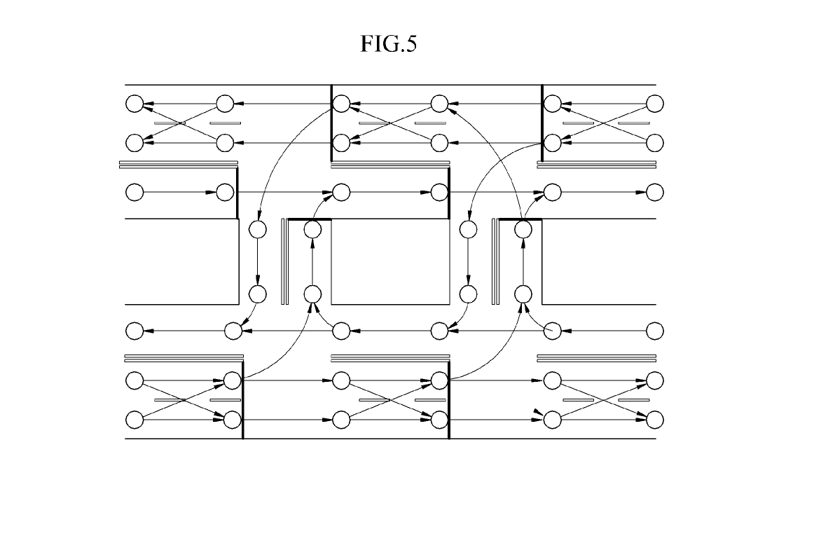

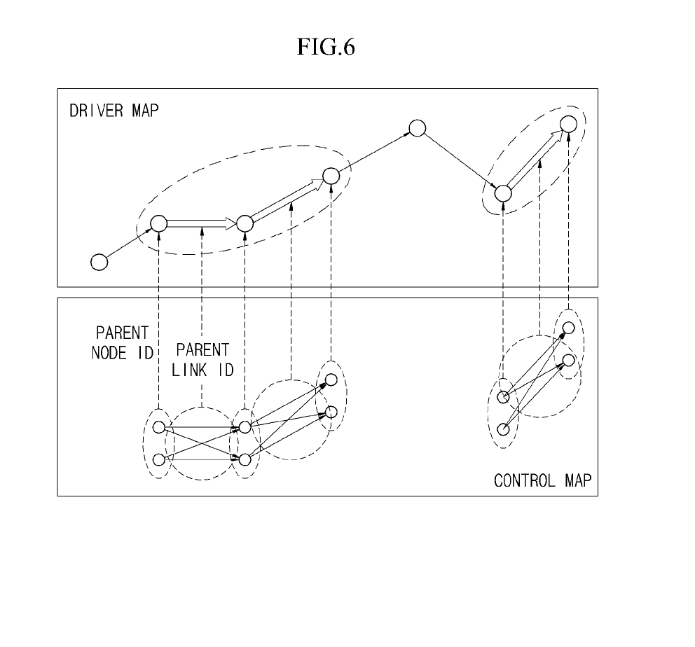

FIGS. 4 and 5 are drawings illustrating road network data of a driver map and an autonomous traveling map which are used for path planning on the same road, and FIG. 6 is a drawing illustrating a mapping process of a driver map and an autonomous traveling map.

In FIGS. 4 and 5, circles indicate nodes, and arrows indicate directivity between links for connecting nodes. In the case of the driver map as shown in FIG. 4, nodes and links do not exist for each lane, and a single link exists per one road segment. On the other hand, as can be seen from FIG. 5, in the case of the autonomous traveling map, nodes and links exist for each lane of a road, and a lane change link exists in a road region in which lane change can be performed.

In this instance, in the case of the driver map, the map of the vehicle navigation device which has been already constructed on a national scale may be used as is. On the other hand, it is not easy to construct the autonomous traveling map on a national scale and it is not easy to update changes due to road construction and the like into the latest information, and therefore the autonomous traveling map may be partially constructed for partial sections of dedicated roads for autonomous traveling vehicles, highway, main roads, or the like.

In FIG. 6, the mapping process of the driver map and the autonomous traveling map is shown. As shown in FIG. 5, the autonomous traveling map is partially constructed, and each node and link of the autonomous traveling map are stored to have a mapping relationship with corresponding node and link of the driver map using node and link IDs (parent node ID and parent link ID), and is used in planning the detailed global path.

Meanwhile, a case in which the autonomous traveling vehicle makes an effort to travel along the global path as much as possible using the global path as a reference path but cannot achieve this in accordance with a road environment may be generated, and in this manner, a case in which the corresponding vehicle cannot follow the global path will be described.

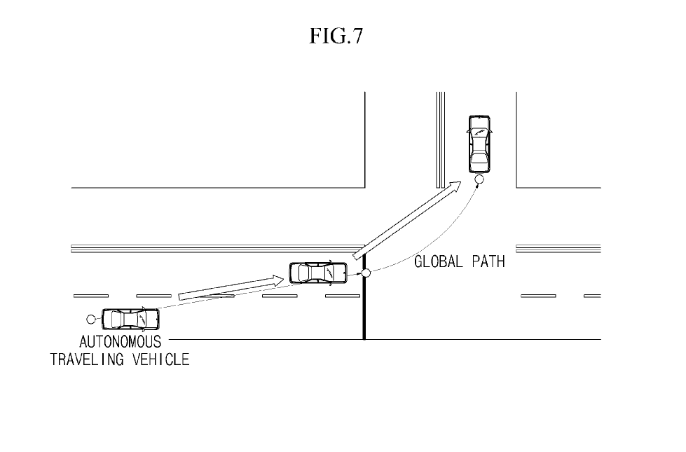

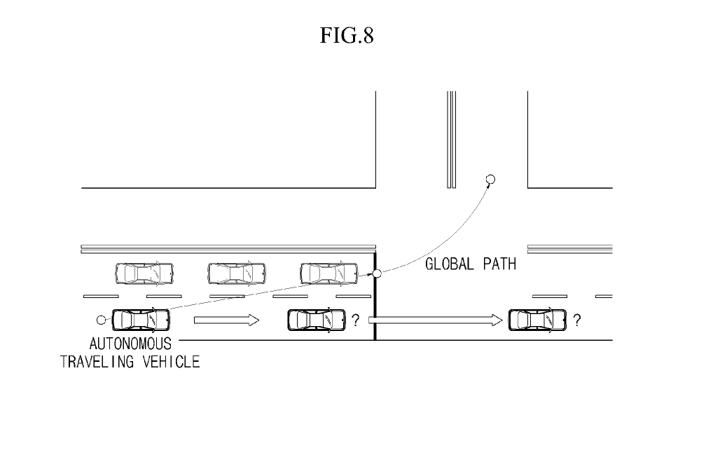

FIG. 7 is a drawing illustrating a case in which a normal lane change and a left turn according to global path planning are performed, and FIG. 8 is a diagram illustrating a state in which traveling is not performed according to global path planning.

In FIG. 7, in a case in which other vehicles do not exist on a road, a normal situation in which the autonomous traveling vehicle performs lane change from a second lane to a first lane to turn left at an intersection and passes turning to the left at the intersection is shown.

On the other hand, as shown in FIG. 8, in a case in which other vehicles exist in the first lane so that the autonomous traveling vehicle moves to the intersection without performing lane change, the global path which the corresponding vehicle can follow does not exist. In a situation in which a general driver cannot travel in a lane recommended by the vehicle navigation device, the driver may take an action such as traveling straight or moving to a safe shoulder while re-searching for the corresponding path to overcome the corresponding situation. However, in the case of the autonomous traveling vehicle, when there is no global path which the autonomous traveling vehicle can follow, the autonomous traveling vehicle may stop while failing to travel any more or can not take the next action for traveling.

In addition, even when the autonomous traveling vehicle takes a decision to travel straight or the like in the same manner as that performed by the driver, path planning of the autonomous traveling map is time-consuming on the re-search, so that it is difficult for the autonomous traveling vehicle to travel.

Therefore, in the present invention, there is suggested a global path planning method for solving problems that occur when the autonomous traveling vehicle cannot follow the global path at an intersection using the vehicle autonomous traveling system of FIGS. 1 to 3, as shown in FIG. 8.

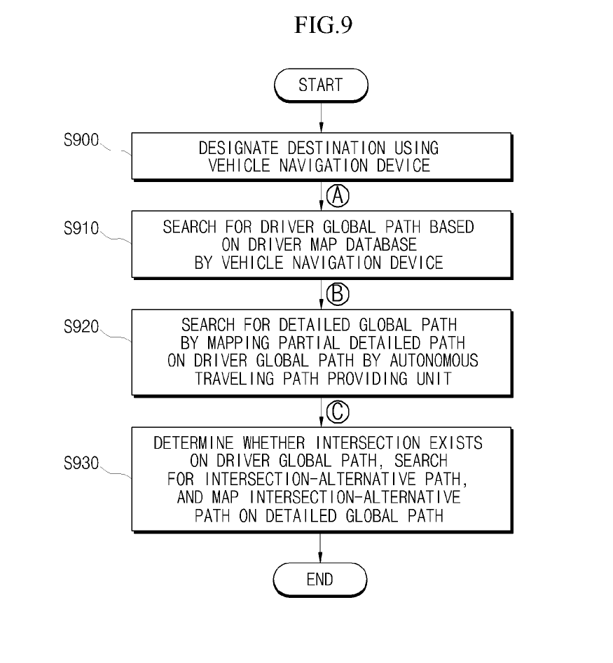

FIG. 9 is a flowchart illustrating a procedure for planning a global path according to an embodiment of the present invention.

Referring to FIG. 9, when a driver designates a destination using the vehicle navigation device 110 in operation S900, the vehicle navigation device 110 searches for a driver global path based on information stored in the driver map database 111 in operation S910.

In this instance, when searching for the driver global path based on the information stored in the driver map database 111 in operation S910, the vehicle navigation device 110 may search for the global path using an A* algorithm, a Dijkstra's algorithm, or the like, and the present invention is not limited thereto.

The driver global path searched in operation S910 is transmitted to the autonomous traveling path providing unit 130 via a network within the vehicle.

In operation S920, the autonomous traveling path providing unit 130 that has received the driver global path transmitted from the vehicle navigation device 110 may search for a detailed global path by mapping a partial detailed path on the driver global path.

In this instance, the autonomous traveling path providing unit 130 may determine whether the corresponding partial detailed path exists on the driver global path within the autonomous traveling map database 131, and map the corresponding partial detailed path on the driver global path when it is determined that the corresponding partial detailed path exists.

After searching for the detailed global path in operation S920, the autonomous traveling path providing unit 130 determines whether an intersection exists on the driver global path, searches for an intersection-alternative path when it is determined that the intersection exists, and maps the searched intersection-alternative path on the detailed global path in operation S930, thereby terminating the global path planning.

In this instance, the autonomous traveling path providing unit 130 determines whether the intersection exists on the driver global path, and terminates the global path planning when it is determined that the intersection does not exist.

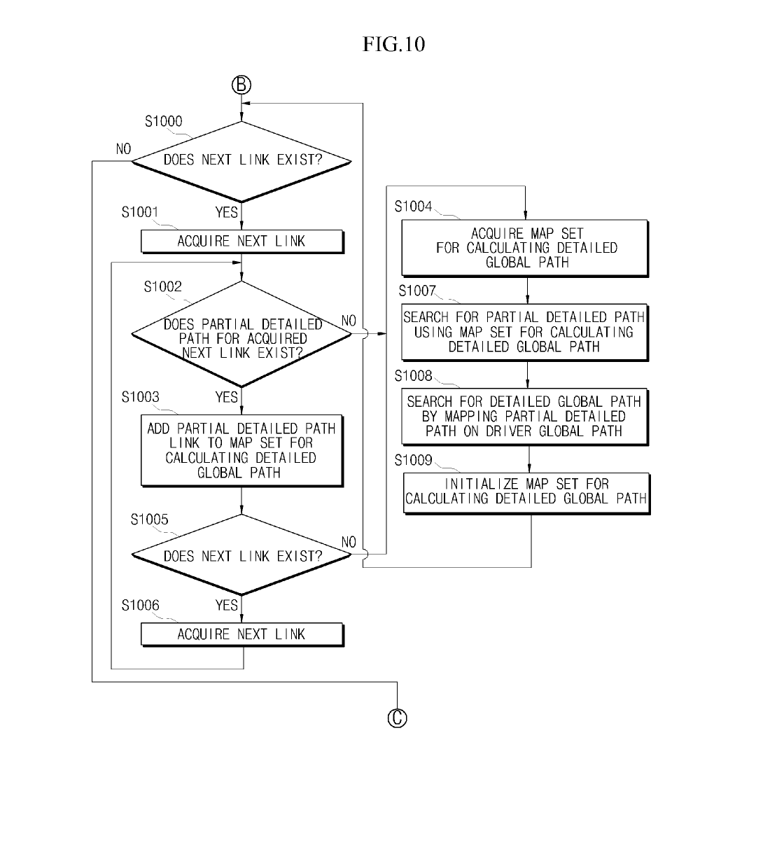

FIG. 10 is a flowchart illustrating a detailed procedure for searching for a detailed global path shown in FIG. 9. In this instance, searching for the detailed global path may be performed by the autonomous traveling path providing unit 130.

Referring to FIG. 10, when receiving the driver global path in the same manner as that in FIG. 9, the autonomous traveling path providing unit 130 determines whether the next link of the driver global path exists in operation S1000.

When it is determined that the next link of the driver global path exists in operation S1000—Yes, the autonomous traveling path providing unit 130 acquires the next link in operation S1001, and when it is determined that the next link does not exist in operation S1000—No, the autonomous traveling path providing unit 130 terminates the searching of the detailed global path.

When it is determined that the next link exists and the next link is acquired in operation S1001, the autonomous traveling path providing unit 130 determines whether a partial detailed path for the acquired next link exists in the autonomous traveling map database in operation S1002.

When it is determined that the partial detailed path for the acquired next link exists in the autonomous traveling map database in operation S1002—Yes, the autonomous traveling path providing unit 130 adds a partial detailed path link to a map set for calculating the detailed global path in operation S1003.

On the other hand, when it is determined that the partial detailed path for the acquired next link does not exist in the autonomous traveling map database in operation S1002—No, the autonomous traveling path providing unit 130 acquires the map set for calculating the detailed global path in operation S1004.

Meanwhile, after adding the partial detailed path link to the map set for calculating the detailed global path in operation S1003, the autonomous traveling path providing unit 130 determines whether the next link of the driver global path exists in operation S1005.

When it is determined that the next link of the driver global path exists in operation S1005-Yes, the autonomous traveling path providing unit 130 acquires the next link in operation S1006, and proceeds to operation S1002 in which the autonomous traveling path providing unit 130 determines whether the partial detailed path for the acquired next link exists in the autonomous traveling map database.

When it is determined that the next link of the driver global path does not exist in operation S1005—No, operation S1004 of acquiring the map set for calculating the detailed global path is performed.

Meanwhile, after operation S1004 of acquiring the map set for calculating the detailed global path, the autonomous traveling path providing unit 130 searches for a partial detailed path using the acquired map set for calculating the detailed global path in operation S1007.

When the partial detailed path is searched for using the acquired map set for calculating the detailed global path in operation S1007, a departure point is a set of all start links within the map set for calculating the detailed global path, and a destination is the destination (final destination) designated by the driver using the vehicle navigation device 110 in operation S900 of FIG. 9.

That is, a path from each start link to a link closest to the final destination among final links of the map set for calculating the detailed global path may be searched.

After searching for the partial detailed path in operation S1007, the autonomous traveling path providing unit 130 searches for the detailed global path by mapping the partial detailed path on the driver global path in operation S1008, initializes the map set for calculating the detailed global path in operation S1009, and then proceeds to operation S1000 to determine whether the next link of the driver global path exists.

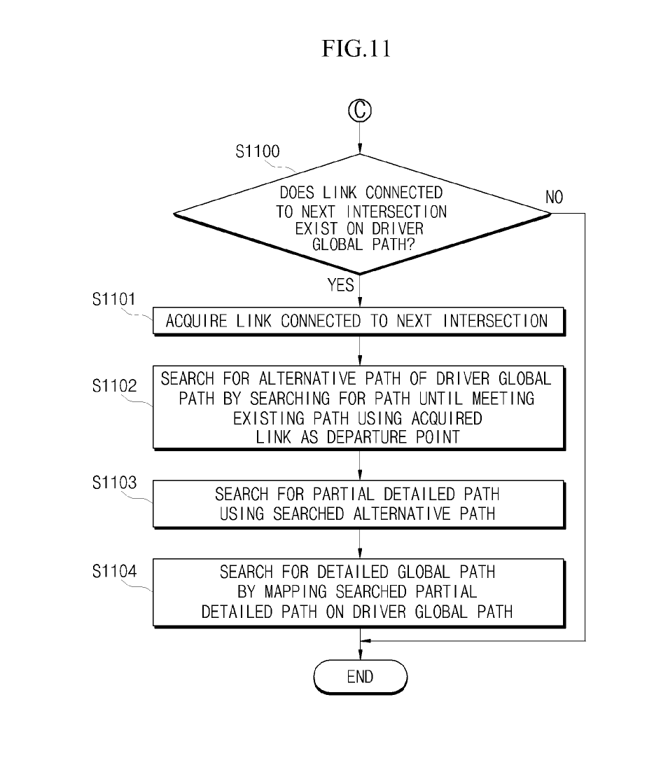

FIG. 11 is a flowchart illustrating a detailed procedure for searching for an intersection-alternative path shown in FIG. 9. In this instance, searching for the detailed global path may be performed by the autonomous traveling path providing unit 130.

Referring to FIG. 11, when receiving the detailed global path in the same manner as that in FIG. 9, the autonomous traveling path providing unit 130 determines whether a link connected to the next intersection exists on the driver global path in operation S1100. In this instance, the link connected to the next intersection is a link having connection information of links branched at the corresponding intersection. When it is determined that the link connected to the next intersection exists in operation S1100—Yes, the autonomous traveling path providing unit 130 acquires the link connected to the next intersection in operation S1101, and when it is determined that the link connected to the next intersection does not exist in operation S1100—No, the autonomous traveling path providing unit 130 terminates searching for the intersection-alternative path.

Meanwhile, when acquiring the link connected to the next intersection in operation S1101, the autonomous traveling path providing unit 130 searches for an alternative path of the driver global path by searching for a path until meeting an existing path using the acquired link as a departure point in operation S1102. In this instance, when searching for the alternative path of the driver global path in operation S1102, a link included in the existing path is excluded.

Meanwhile, after searching for the alternative path of the driver global path, the autonomous traveling path providing unit 130 searches for a partial detailed path using the searched alternative path in operation S1103, and searches for a detailed global path by mapping the searched partial detailed path on the driver global path in operation S1104.

According to the method of searching for the intersection-alternative path shown in FIG. 11, only some alternative paths are calculated in advance in order to reduce a recalculation time without searching for alternative paths for all intersections, and the alternative path which is not calculated during traveling is calculated, and therefore it is possible to reduce a path searching time which is initially consumed.

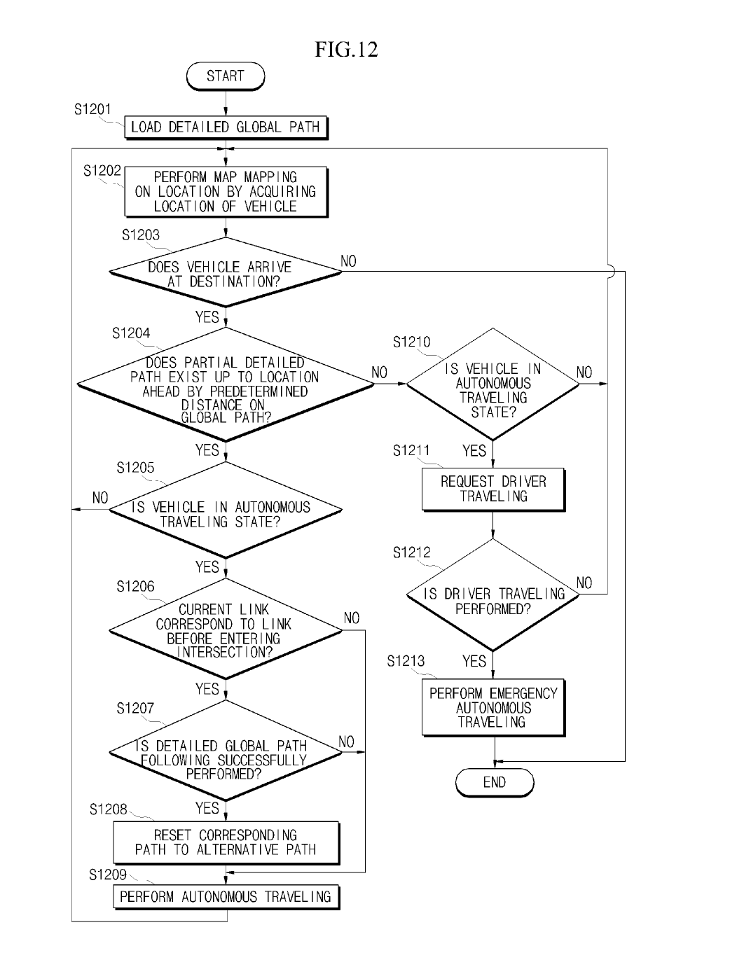

As above, the detailed configuration and function of the vehicle autonomous traveling system and the method of searching for the detailed global path for the purpose of autonomous traveling have been described. Hereinafter, a vehicle traveling method using the vehicle autonomous traveling system according to an embodiment of the present invention corresponding to the operations of the vehicle autonomous traveling system according to the above-described embodiment will be described with reference to FIG. 12 in a stepwise manner.

FIG. 12 is a flowchart illustrating a vehicle traveling method using a vehicle autonomous traveling system according to an embodiment of the present invention.

Referring to FIG. 12, the vehicle traveling method loads a planned detailed global path in operation S1201, and performs map matching on a location of a vehicle acquired by the vehicle location recognition unit 137 in operation S1202.

In this instance, in operation S1201 of loading the planned detailed global path, the detailed global path is a path that is planned through the process described in FIGS. 9 to 11.

After performing map matching in operation S1202, the vehicle traveling method determines whether the vehicle arrives at a destination in operation S1203, and when it is determined that the vehicle arrives at the destination in operation S1203—Yes, vehicle autonomous traveling guiding is terminated.

Meanwhile, the vehicle traveling method determines whether the vehicle arrives at the destination in operation S1203. Next, when it is determined that the vehicle does not arrive at the destination in operation S1203—No, the vehicle traveling method determines whether a partial detailed path exists up to a location ahead by a predetermined distance on the detailed global path in operation S1204.

When it is determined that the partial detailed path exists in operation S1204—Yes, the vehicle traveling method determines whether the vehicle is in an autonomous traveling state in operation S1205.

When it is determined that the vehicle is not in the autonomous traveling state in operation S1205—No, the vehicle traveling method proceeds to operation S1202 to perform map matching on the location of the vehicle acquired by the vehicle location recognition unit 137.

On the other hand, when it is determined that the vehicle is in the autonomous traveling state in operation S1205-Yes, the vehicle traveling method determines whether a current link is a link before the vehicle enters an intersection in operation S1206.

When it is determined that the current link is the link before the vehicle enters the intersection in operation S1206—Yes, the vehicle traveling method determines whether detailed global path following is successfully performed in operation S1207, and when it is determined that the current link is not the link before the vehicle enters the intersection in operation S1206—No, the vehicle traveling method performs autonomous traveling in operation S1209.

Meanwhile, when it is determined that the detailed global path following is successfully performed in operation S1207—Yes, the vehicle traveling method performs autonomous traveling S1209.

On the other hand, when it is determined that the detailed global path following is not successfully performed in operation S1207—No, the vehicle traveling method resets the corresponding path to an alternative path in operation S1208, and then performs autonomous traveling in operation S1209.

Meanwhile, when it is determined that the partial detailed path does not exist up to the location ahead by the predetermined distance on the detailed global path in operation S1204—No, the vehicle traveling method determines whether the vehicle is in the autonomous traveling state in operation S1210. Next, when it is determined that the vehicle is not in the autonomous traveling state in operation S1210—No, the vehicle traveling method proceeds to operation S1202 to acquire the location of the vehicle and perform map matching on the acquired location.

On the other hand, when it is determined that the vehicle is in the autonomous traveling state in operation S1210—Yes, the vehicle traveling method requests driver traveling in operation 51211, and determines whether the driver traveling is performed in operation S1212.

In this instance, when it is determined that the driver traveling is performed in operation S1212—Yes, the vehicle traveling method proceeds to operation S1202 to acquire the location of the vehicle and perform map matching on the acquired location. When it is determined that the driver traveling is not performed in operation S1212—No, the vehicle traveling method performs emergency autonomous such as stop or the like in operation S1213.

As described above, according to the vehicle autonomous traveling system and the vehicle traveling method using the same according to the embodiments of the present invention, the detailed global path may be planned using the map provided by the vehicle navigation device which has been already constructed on a national scale and the partial detailed map existing within the autonomous traveling system.

In addition, according to the embodiments of the present invention, by determining whether an intersection exists on the global path, searching for an intersection-alternative path, and mapping the intersection-alternative path on the global path, it is possible to plan the detailed global path including the intersection-alternative path.

Thus, a detailed map of a lane level for the entire path may not be required, and an incident that may occur when the autonomous traveling system fails to follow the global path may be prevented.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A vehicle autonomous traveling system comprising:
a vehicle navigation device that plans a driver global path to a destination by acquiring a location of a vehicle, and guides a path in accordance with the planned driver global path;
an autonomous traveling path providing unit that recognizes a road environment while planning a detailed global path by mapping a partial detailed path of a lane level based on the driver global path, determines a traveling condition based on the detailed global path and the recognized road environment, and outputs vehicle traveling information for controlling the vehicle; and
an autonomous traveling operation unit that receives the vehicle traveling information, and performs autonomous traveling of the vehicle by following a path included in the vehicle traveling information.

2. The vehicle autonomous traveling system of claim 1, wherein the vehicle navigation device includes
a driver map database that stores a vehicle navigation map,
a vehicle location recognition unit that recognizes the location of the vehicle using a positioning system, and
a global path planning unit that plans the driver global path of the vehicle using location information recognized by the vehicle location recognition unit and the vehicle navigation map stored in the driver map database.

3. The vehicle autonomous traveling system of claim 1, wherein the autonomous traveling path providing unit includes
an autonomous traveling map database that stores a map of a lane level for a predetermined section,
a detailed global path planning unit that plans the detailed global path using the map stored in the autonomous traveling map database and the driver global path provided from the vehicle navigation device,
a vehicle location recognition unit that acquires the location of the vehicle and heading information of the vehicle,
an autonomous traveling environment recognition unit that recognizes the road environment for autonomous traveling, and
an autonomous traveling path planning unit that determines the traveling condition based on the detailed global path, the road environment, and location information of the vehicle, and outputs the vehicle traveling information.

4. The vehicle autonomous traveling system of claim 3, wherein, when an intersection exists on the driver global path, the autonomous traveling path providing unit searches for a lane-alternative path, and maps the searched lane-alternative path on the detailed global path.

5. The vehicle autonomous traveling system of claim 3, wherein the vehicle location recognition unit is implemented as a global positioning system (GPS)/inertial measurement unit (IMU) for acquiring highly accurate location information.

6. The vehicle autonomous traveling system of claim 1, wherein the vehicle navigation device and the autonomous traveling path providing unit communicate with each other via a network within the vehicle.

7. A vehicle traveling method using a vehicle autonomous traveling system, comprising:
loading a planned detailed global path;
acquiring a location of a vehicle to perform map matching on the acquired location;
determining whether the vehicle arrives at a destination, and determining whether a partial detailed path exists up to a location ahead by a predetermined distance on the detailed global path when it is determined that the vehicle does not arrive at the destination;
performing autonomous traveling or performing map matching on the acquired location by determining whether the vehicle is in an autonomous traveling state when it is determined that the partial detailed path exists; and
performing emergency autonomous traveling or performing map matching on the acquired location by determining whether the vehicle is in the autonomous traveling state when it is determined that the partial detailed path does not exist.

8. The vehicle traveling method of claim 7, wherein the performing of autonomous traveling or the performing of the map matching includes
performing autonomous traveling when it is determined that the vehicle is in the autonomous traveling state in a case in which the partial detailed path is determined to exist, and
performing map matching on the acquired location when it is determined that the vehicle is not in the autonomous traveling state.

9. The vehicle traveling method of claim 7, wherein the performing of the map matching includes performing map matching on the acquired position when it is determined that the vehicle is not in the autonomous traveling state.

10. The vehicle traveling method of claim 7, wherein the performing of the map matching includes
requesting driver traveling when it is determined that the vehicle is in the autonomous traveling state, and
determining whether the driver traveling is performed.

11. The vehicle traveling method of claim 10, wherein the determining of whether the driver traveling is performed includes
performing map matching on the acquired location when it is determined that the driver traveling is performed, and
performing emergency autonomous traveling when it is determined that the driver traveling is not performed.

12. The vehicle traveling method of claim 8, wherein the performing of autonomous traveling or the performing of the map matching includes
determining whether a current link is a link before the vehicle enters an intersection when it is determined that the vehicle is in the autonomous traveling state,
performing autonomous traveling when it is determined that the current link is not the link before the vehicle enters the intersection, and
determining whether detailed global path following is successfully performed when it is determined that the current link is the link before the vehicle enters the intersection.

13. The vehicle traveling method of claim 12, wherein the determining of whether the detailed global path following is successfully performed includes
performing autonomous traveling when it is determined that the detailed global path following is successfully performed, and
resetting the corresponding path to an alternative path when it is determined that the detailed global path following is not successfully performed, and performing autonomous traveling.

14. The vehicle traveling method of claim 7, wherein the loading of the planned detailed global path includes
designating the destination using a vehicle navigation device,
searching for a driver global path based on a driver map database in which a vehicle navigation map is stored, and
planning for the detailed global path by mapping the partial detailed path on the driver global path.

15. The vehicle traveling method of claim 14, wherein, after the mapping of the partial detailed path on the driver global path, the loading of the planned detailed global path further includes
searching for an intersection-alternative path by determining whether an intersection exists on the driver global path, and
searching for the detailed global path by mapping the intersection-alternative path on the detailed global path.

16. The vehicle traveling method of claim 14, wherein the planning of the detailed global path by mapping the partial detailed path on the driver global path includes
determining whether a next link of the driver global path exists,
acquiring the next link when it is determined that the next link of the driver global path exists, and determining whether a partial detailed path for the next link exists, and
adding a partial detailed path link to a map set for calculating the detailed global path when it is determined that the partial detailed path for the next link exists, and searching for the detailed global path based on the map set for calculating the detailed global path when it is determined that the partial detailed path for the next link does not exist.

17. The vehicle traveling method of claim 16, wherein the searching for of the detailed global path based on the map set includes
acquiring the map set for calculating the detailed global path,
searching for the partial detailed path using the map set for calculating the detailed global path, and
searching for the detailed global path by mapping the partial detailed path on the driver global path.

18. The vehicle traveling method of claim 16, wherein, after the adding of the partial detailed path link to the map set for calculating the detailed global path, the planning of the detailed global path by mapping the partial detailed path on the driver global path further includes
determining whether the next link of the driver global path exists, and
acquiring the next link when it is determined that the next link of the driver global path exists.

19. The vehicle traveling method of claim 18, wherein the planning of the detailed global path by mapping the partial detailed path on the driver global path further includes
determining whether the next link of the driver global path exists, and
searching for the detailed global path based on the map set for calculating the detailed global path when it is determined that the next link of the driver global path does not exist.

20. The vehicle traveling method of claim 15, wherein the searching for of the detailed global path by mapping the intersection-alternative path on the detailed global path includes
determining whether a link connected to a next intersection exists in the driver global path,
acquiring the link connected to the next intersection when it is determined that the link connected to the next intersection exists in the driver global path,
searching for an alternative path of the driver global path by searching for a path until the vehicle meets an existing path using the acquired link as a departure point,
searching for the partial detailed path using the searched alternative path, and
searching for the detailed global path by mapping the searched partial detailed path on the driver global path.
